(19) United States
(12) Patent Application Publication
(10) Pub. No.: US 2007/0052204 A1
(43) Pub. Date: Mar. 8, 2007

(54) Fifth wheel hitch

(75) Inventor: Craig A. Kaplenski, Jackson, SC (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Patent Creators LLC

(21) Appl. No.: 11/440,954

(22) Filed: May 25, 2006

Related U.S. Application Data
(60) Provisional application No. 60/684,938, filed on May 26, 2005.

(51) Int. Cl. B60D 1/32

(52) U.S. Cl. 280/455.1

(57) ABSTRACT

An air hitch includes an air spring, a mounting base, and a head unit. The air spring is configured with a first and second end, and an inflatable bag configured between the two ends. A pivot unit within the bag allows for up-and-down sliding and pivoting. When the inflatable bag is under pressure, mechanical shocks and other destabilizing forces are substantially dampened.

### PRIORITY

The present application claims priority to (1) U.S. Provisional Patent Application No. 60/684,938 entitled “Fifth Wheel Hitch” filed May 25, 2005 and (2) U.S. Pat. Application No. ______ entitled “Air Jack” filed May 23, 2006, which claims priority to U.S. Provisional Patent Application No. 60/684,009. The entire contents of each of these are hereby incorporated by reference in their entirety.

### FIELD

The invention relates generally to a fifth wheel hitch for connecting a truck or other tow vehicle to a trailer.

### BACKGROUND AND SUMMARY

A trailer hitch is disclosed that includes a guide pin assembly providing front-to-rear and side-to-side control. Up and down damping control and 360 degrees of yaw control provides substantial isolation between a tow vehicle and trailer. One or more air springs may be incorporated into the design to reduce effects of various road conditions.

### DESCRIPTION OF THE DRAWINGS

The attached figures are diagrams that show various angles of one embodiment of the trailer hitch. As depicted in more detail in the figures, the air hitch can attach to a tow vehicle frame.

FIG. 1 is a perspective view of an air hitch.

FIG. 2 is a side view of an air hitch.

FIG. 3 is a top view of an air hitch.

FIG. 4 is a front view of an air hitch.

FIG. 5 provides front side and rear views of a pin and guide assembly.

FIG. 6 provides a front view of a fifth wheel air hitch.

FIG. 7 is a front view of another embodiment of a fifth wheel air hitch.

FIG. 8 shows a more detailed view of an air spring used in an air hitch.

FIG. 9 shows a more detailed view of a ball and pivot portion of the assembly.

FIG. 10 provides an example sliding operation of the ball and pivot portion of the assembly.

FIG. 11 provides an example of a yaw operation of the ball and pivot portion of the assembly.

### DETAILED DESCRIPTION

According to the disclosure, a fifth wheel hitch may be, for example, an 18 wheeler class 8 hitch. This is merely exemplary in nature, and the hitch might alternatively be designed for other classes and for other applications. In some embodiments, the hitch might be less than 8″ tall. In a preferred embodiment, the hitch can include one or more air bags or air springs that provide isolation between the tow vehicle and trailer in multiple dimensions. In various embodiments, the trailer hitch includes one air spring. In other embodiments, the hitch includes four air springs.

In a four air spring embodiment, the air springs are preferably positioned at approximately the corners of the hitch. Each of the air springs might operate so as to compress and/or expand substantially independently of the other air springs. This independent operation of the air springs can provide side-to-side and front-to-back control, thereby dampening forces that might otherwise travel between the tow vehicle and trailer. The configuration of the hitch can also provide dampening control in 360 degrees of yaw and dampening control in up-and-down. Thus, the hitch can operate to mechanically isolate the tow vehicle and the trailer, thereby reducing the effects of various road conditions.

A fifth wheel head unit can attach to the trailer. In addition to the air bags and/or air springs, the hitch can include a pivot unit and mounting base. The hitch can also include a guide pin assembly. The outside construction of the hitch can be designed to resist rotational forces. The pivot inside the spring can allow movement around a single, dual or multiple pivots point. The “Air Jack” patent application, which has been incorporated by reference, provides further details on potential air spring designs.

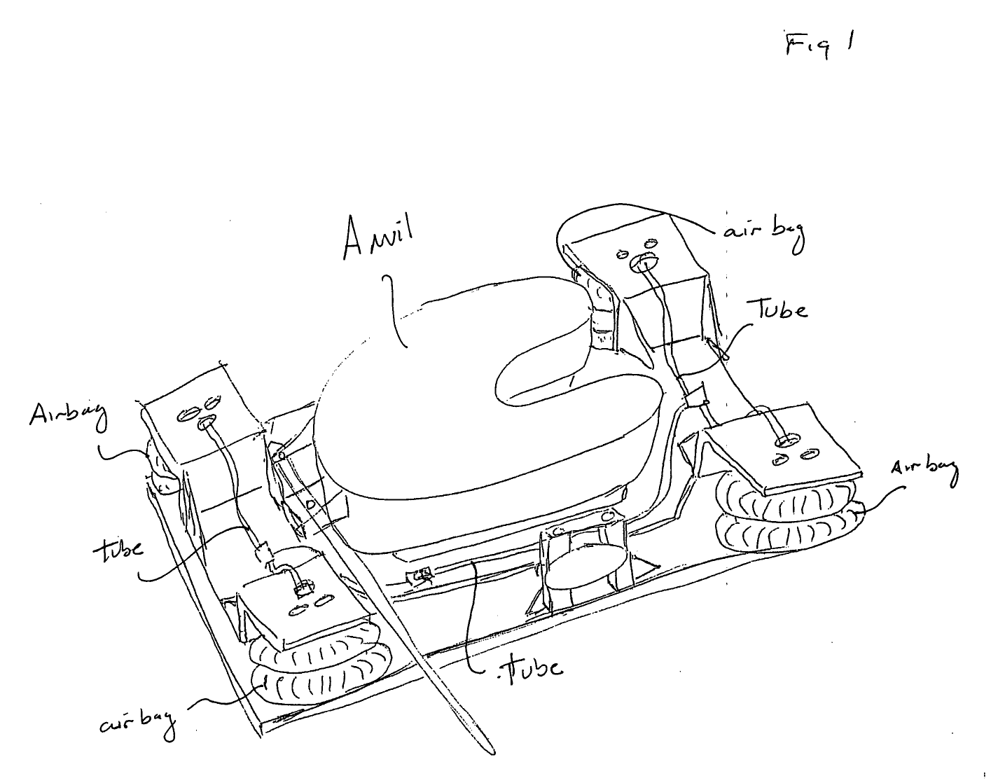

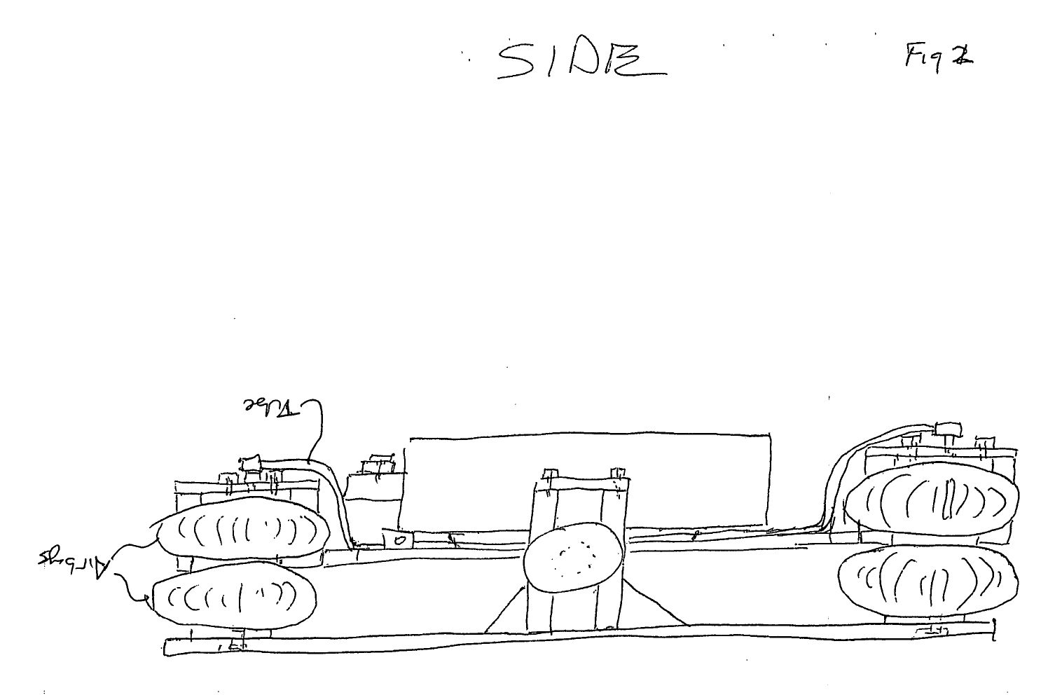

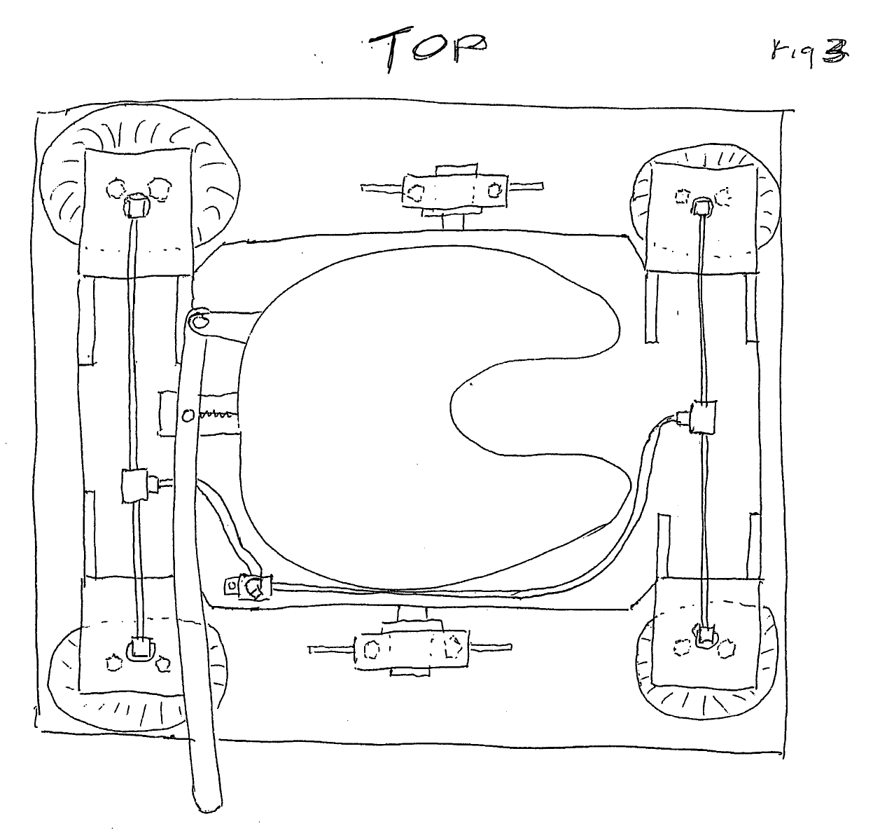

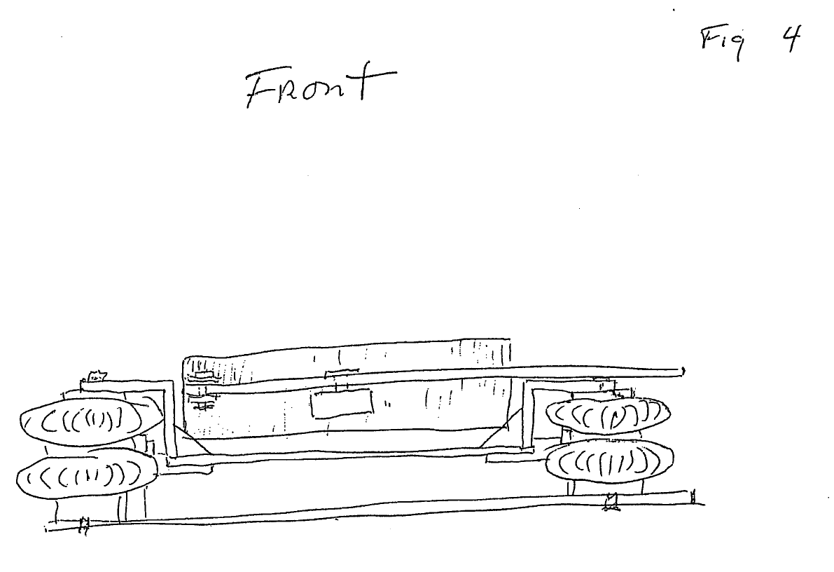

FIG. 1 is a perspective view of a class-8 air hitch that shows air bags at each corner. An anvil portion provides a mechanism for attaching a trailer to the air hitch. At least four air bags are distributed to the corners of the hitch, and a series of tubes are threaded to each air bag to provide an inflationary force. FIG. 2 is a side view of the air hitch of FIG. 1. FIG. 3 is a top view of the air hitch of FIG. 1. FIG. 4 is a front view of the air hitch of FIG. 1. FIG. 5 provides front side and rear views of a pin and guide assembly. The pin and guide assembly is configured to provide up-and-down motion without providing side-to-side or pivoting motion.

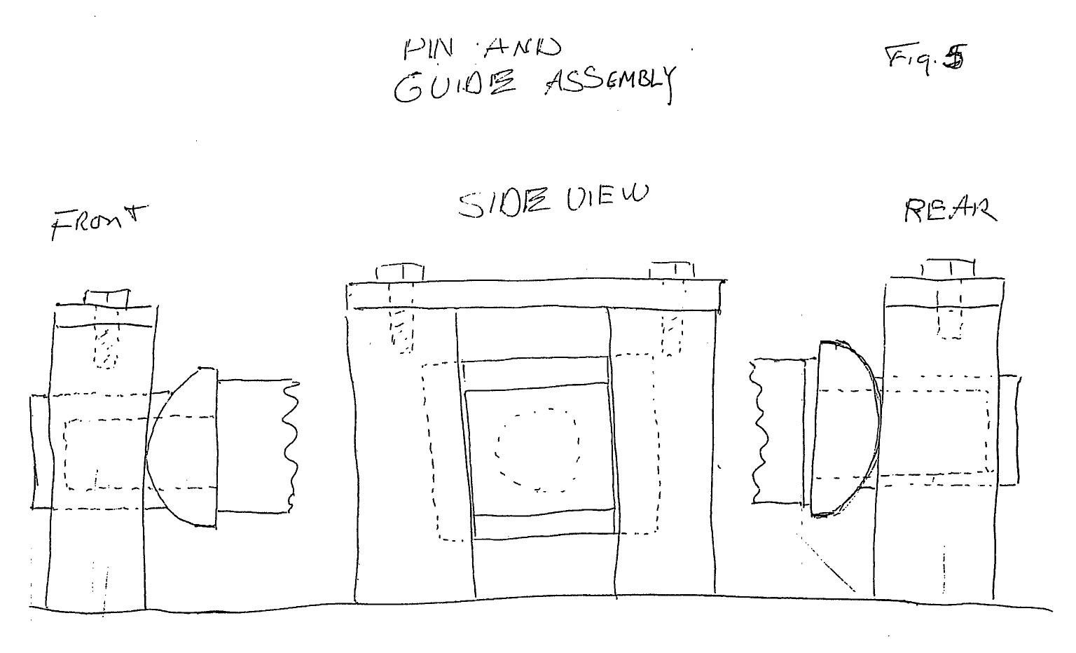

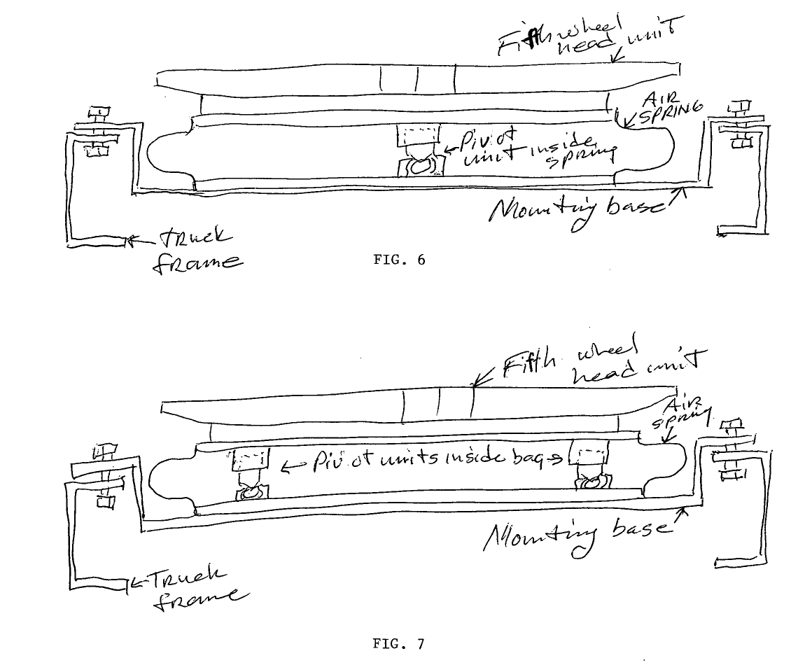

FIG. 6 provides a front view of a fifth wheel air hitch. A fifth wheel head unit facilities attaching a fifth wheel trailer to the hitch. A mounting base is attached to a vehicle such as a truck. An air spring is located between the fifth wheel head unit and the mounting base. He air spring is configured with two ends and an air bag between the two ends. In addition, a pivot unit is located within the air spring. FIG. 7 is a front view of another embodiment of a fifth wheel air hitch. In FIG. 7, additional stability is provided by a pair of pivot units located inside the inflatable air bag.

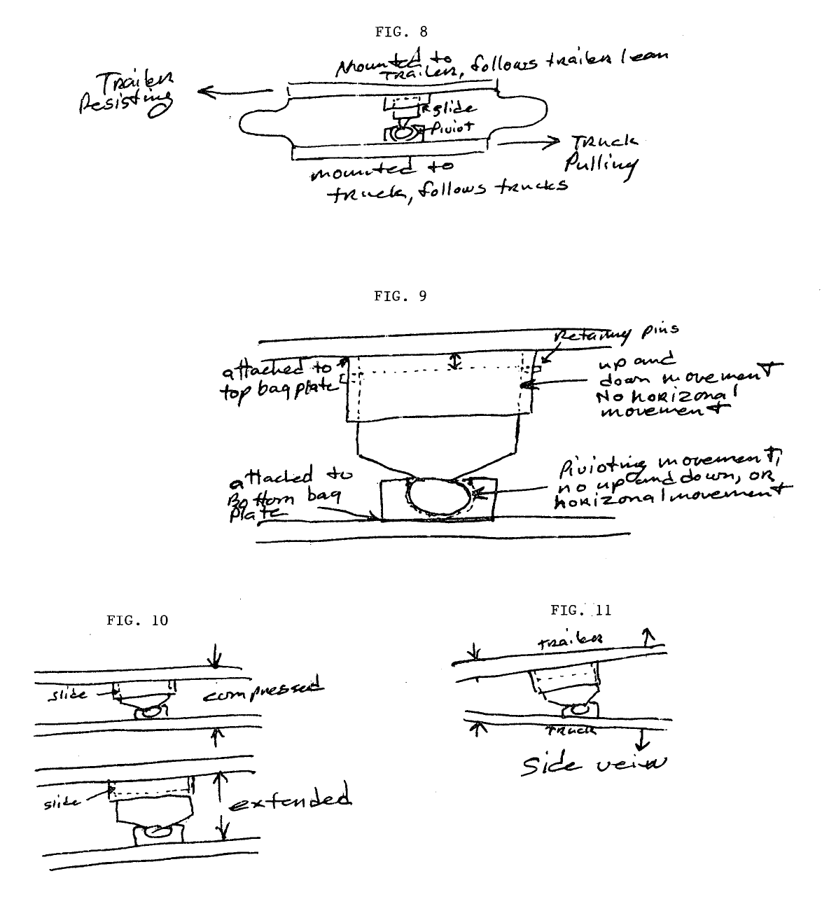

FIG. 8 shows a more detailed view of an air spring used in an air hitch. FIG. 9 shows a more detailed view of a ball and pivot portion of the assembly. In addition, FIG. 9 provides one application of the pin and guide assembly shown in FIG. 5. FIG. 10 provides an example sliding operation of the ball and pivot portion of the assembly. In the upper drawings the sliding portion of the pivot unit is compressed. In the lower drawing the sliding portion of the pivot unit is extended. FIG. 11 provides an example of a yaw operation of the ball and pivot portion of the assembly.

I claim:

1. A trailer hitch comprising:
a guide pin assembly providing front-to-rear and side-to-side control in a horizontal plane; and
an air spring having up and down dampening control and yaw control operating to provide substantial isolation between the a tow vehicle and trailer.

2. The trailer hitch of claim 1, wherein the trailer hitch is a fifth wheel hitch.

3. The trailer hitch of claim 1, wherein the trailer hitch is a class-8 hitch.

4. An air spring comprising a first end; a second end; an inflatable air bag interposed between the first and second ends; and a pivot unit arranged within the inflatable air bag.

5. The air spring of claim 4, wherein the pivot unit includes a first portion attached to the first end and a second portion attached to the second end, wherein two portions are coupled at a ball-and-socket joint.

6. The air spring of claim 4, wherein the pivot unit allows for up-and-down movement and pivoting movement but restricts horizontal movement.

7. The air spring of claim 4, wherein a first end of the air spring is mounted to a truck, and the second end is configured to mount to a trailer.

8. An apparatus comprising:
(a) an air spring including an inflatable air bag and a pivot unit;
(b) a mounting base coupled to the air spring and configured to mount to a vehicle;
(c) a head unit coupled to the air spring and configured to couple with a trailer-type hitch.

9. The apparatus of claim 8, wherein the air spring further comprises a first plate end and a second plate end.
